(19) United States
(12) Patent Application Publication
(10) Pub. No.: US 2007/0129145 A1
(43) Pub. Date: Jun. 7, 2007

(54) Directory service in a service-oriented gaming network environment

(75) Inventors: Christopher W. Blackburn, Reno, NV (US); Rory L. Block, Carson City, NV (US)

Correspondence Address: SCHWEGMAN, LUNDBERG, WOESSNER & KLUTH, P.A., P.O. BOX 2938, MINNEAPOLIS, MN, 55402, US

(73) Assignee: WMS Gaming Inc.

(21) Appl. No.: 11/294,049

(22) Filed: Dec. 5, 2005

(51) Int. Cl. A63F 13/00

(52) U.S. Cl. 463/42; 463/20

(57) ABSTRACT

A gaming network includes a directory service, wagering game machines and service providers. The directory service receives requests for information from the wagering game machines and service providers on the gaming network and provides information relevant to the request to the requester. The directory service and service providers may be implemented as web services with a gaming services framework. The gaming services framework comprises a set of services, protocols, XML schemas, and methods for providing gaming system functionality in a distributed, network based architecture that includes wagering game machines and servers. Systems and methods provide a service-oriented framework for gaming and property management based upon intemetworking technology and web services concepts.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2005, WMS Gaming, Inc.

### Field

The inventive subject matter relates generally to software and hardware systems for wagering game machines, and more particularly to providing a directory service in a service-oriented gaming network environment.

### BACKGROUND

Today's gaming terminal typically comprises a computerized system controlling a video display or reels that provide wagering games such as video and mechanical slots, video card games (poker, blackjack etc.), video keno, video bingo, video pachinko and other games typical in the gaming industry. In addition, support computing systems such as accounting, player tracking and other “back office” systems exist in order to provide support for a gaming environment.

In order to prevent players from becoming bored, new versions of wagering games, and alterations to existing games are constantly being developed. In the past, the game software and content for gaming terminals and back office systems have been developed using proprietary or closed hardware, operating systems, application development systems, and communications systems. Sometimes these systems are provided by a single vendor.

Unfortunately, due to the proprietary and closed nature of existing architectures, it can be difficult to develop new games, and it is difficult to add gaming services to existing proprietary game architectures and gaming network architectures. As a result, the cost and time associated with updating and adding new gaming services to gaming networks is relatively high.

In addition, many wagering game machines and gaming services may exist on a network. These wagering game machines and services typically require authentication and configuration services. In previous systems, the configuration and authentication parameters are maintained on a system by system basis. As a result, changing a configuration parameter that may be common to many machines or services requires each machine or service be manually updated. This can be a time-intensive and laborious process, and can also increase the risk of misconfiguration.

In view of the above-mentioned problems and concerns, there is a need in the art for the inventive subject matter.

### SUMMARY

The above-mentioned shortcomings, disadvantages and problems are addressed by the inventive subject matter, which will be understood by reading and studying the following specification.

One aspect of the systems and methods relates to a directory service for a gaming services framework using web services and internetworking technology. The World Wide Web (“Web” from here on) is a networked information system comprising agents (clients, servers, and other programs) that exchange information. The Web and networking architecture is the set of rules that agents in the system follow, resulting in a shared information space that scales well and behaves predictably. A further aspect relates to providing a directory service in a gaming network.

The Gaming Services Framework comprises a set of services, protocols, XML schemas, and methods for providing secure gaming system functionality in a distributed, network based architecture. It is intended to be a service-oriented framework for gaming and property management based upon intemetworking technology and web services concepts. Specifically, it supports a loosely coupled architecture that consists of software components that semantically encapsulate discrete functionality (self contained and perform a single function or a related group of functions—the component describes its own inputs and outputs in a way that other software can determine what it does, how to invoke its functionality, and what result to expect). These components are distributed and programmatically accessible (called by and exchange data with other software) over standard intemetworking protocols (TCP/IP, HITP, DNS, DHCP, etc.).

The inventive subject matter describes systems, methods, and computer-readable media of varying scope. In addition to the aspects and advantages of the inventive subject matter described in this summary, further aspects and advantages of the inventive subject matter will become apparent by reference to the drawings and by reading the detailed description that follows.

### BRIEF DESCRIPTION OF THE DRAWINGS

FIG. 1 is a perspective view of an exemplary wagering game machine incorporated in the embodiments of the invention.

FIG. 2 is a block diagram providing an example of a service-oriented network for distributed management in a gaming environment according to example embodiments.

FIG. 3 is a block diagram providing a general description of service-oriented interaction according to example embodiments..

FIG. 4 is a representation of a Gaming Services Protocol Stack according to embodiments of the invention.

FIGS. 5A and 5B are flow diagrams illustrating methods and message flows for a providing a directory service according to embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the inventive subject matter may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the inventive subject matter. Numerous alternatives could be implemented, using combinations of current or future technologies, which would still fall within the scope of the claims. The inventive subject matter is directed to a service-oriented framework for gaming networks that allows for the interoperability of the software components (regardless of manufacturer, operating system, or application) reducing the dependence on a closed-system, single vendor solutions and allowing for variety in innovation and competition.

The following detailed description is, therefore, not to be taken in a limiting sense, and the scope of the inventive subject matter is defined only by the appended claims.

### Operating Environment

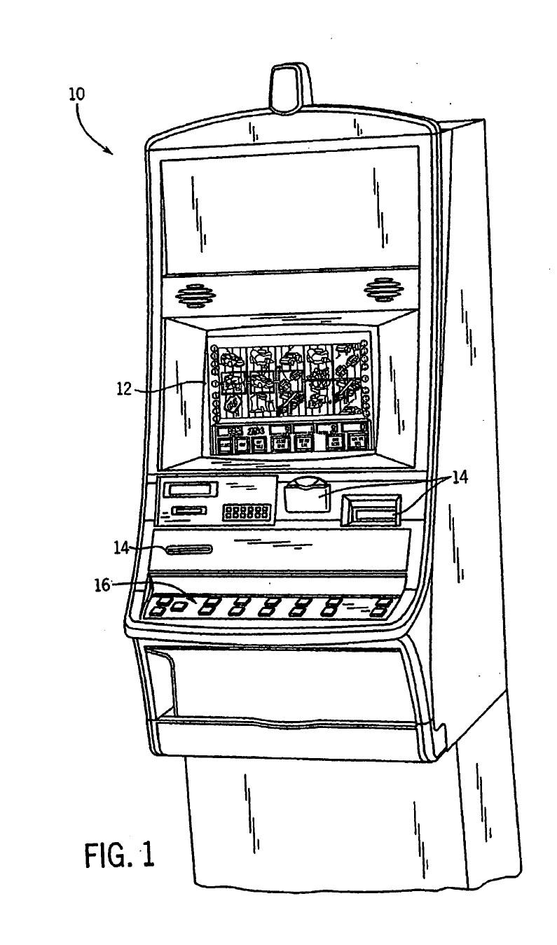

FIG. 1 illustrates an exemplary wagering game machine 10 in which embodiments of the invention may be implemented. In some embodiments, wagering game machine 10 is operable to conduct a wagering game. These wagering games may include reel based games such as video or mechanical slot machine games, card based games such as video poker, video dice games (e.g. a Yahtzee® like dice game) or other types of wagering games typical in the gaming industry. If based in video, the wagering game machine 10 includes a video display 12 such as a cathode ray tube (CRT), liquid crystal display (LCD), plasma, or other type of video display known in the art. A touch screen preferably overlies the display 12. In the illustrated embodiment, the wagering game machine 10 is an “upright” version in which the display 12 is oriented vertically relative to a player. Alternatively, the wagering game machine may be a “slant-top” version in which the display 12 is slanted at about a thirty-degree angle toward the player. Further, the wagering game machine may be a “bar-top” version in which the display is mounted horizontally in a bar top or table top. Still further, the wagering game machine may be housed in a wall mounted or other vertically mounted cabinet. In yet further embodiments, the wagering game machine may be housed in a portable or handheld device. In such devices, the user interface elements (buttons, screen etc.) may be scaled down or eliminated in order to fit the elements into an appropriate housing for a handheld or portable wagering game machine.

The wagering game machine 10 includes a plurality of possible credit receiving mechanisms 14 for receiving credits to be used for placing wagers in the game. The credit receiving mechanisms 14 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the wagering game machine 10 includes a user interface comprising a plurality of push-buttons 16, the above-noted touch screen, and other possible devices. The plurality of push-buttons 16 may, for example, include one or more “bet” buttons for wagering, a “play” button for commencing play, a “collect” button for cashing out, a help” button for viewing a help screen, a “pay table” button for viewing the pay table(s), and a “call attendant” button for calling an attendant. Additional game specific buttons may be provided to facilitate play of the specific game executed on the machine. The touch screen may define touch keys for implementing many of the same functions as the push-buttons. Additionally, in the case of video poker, the touch screen may implement a card identification function to indicate which cards a player desires to keep for the next round. Other possible user interface devices include a keyboard and a pointing device such as a mouse or trackball.

A processor controls operation of the wagering game machine 10. In response to receiving a wager and a command to initiate play, the processor randomly selects a game outcome from a plurality of possible outcomes and causes the display 12 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the processor awards the player with a number of credits associated with the winning outcome.

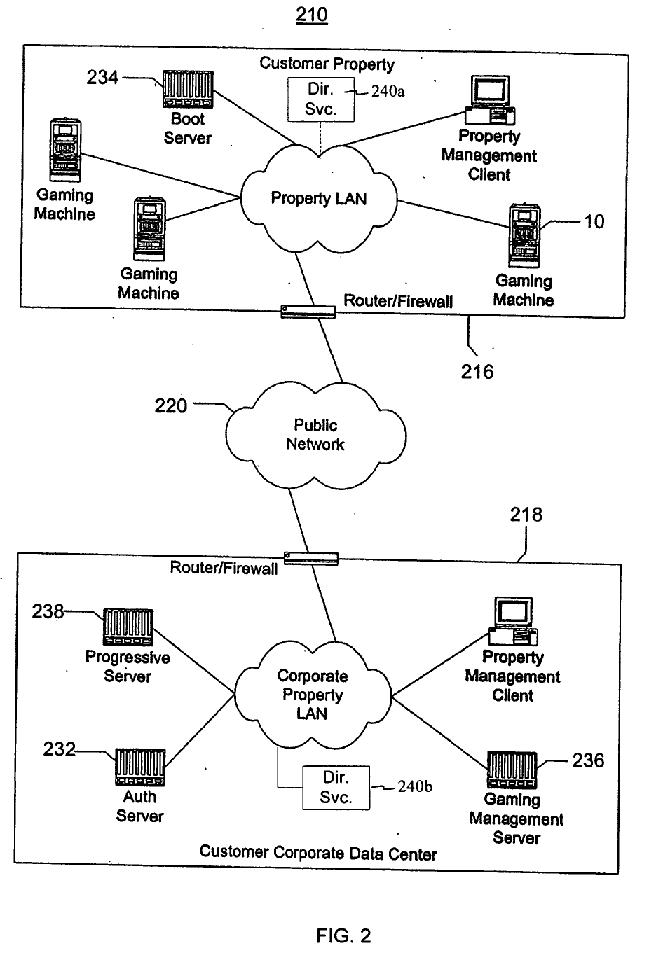

FIG. 2 illustrates an example of a Gaming Service Network 210 comprising a customer data center 218 and a customer property 216. The data center 218 and customer property 216 are connected via a network 220. In some embodiments, network 220 is a public network such as the Internet. However, in alternative embodiments, private networks, including corporate intranets or extranets may be used to connect a data center 218 with one or more properties 216.

In some embodiments, the Customer Corporate Data Center 218 contains the bulk of the network servers supporting gaming properties owned by the corporation. Major elements of the gaming service network include Auth server 232, Gaming Management Server 236, and Progressive Server 238. In some embodiments, Auth Server 32 provides authentication, authorization and content integrity for client devices attempting to interact with other servers and services in the architecture.

In some embodiments, the Gaming Management Server 236 includes the following services: Boot Service, Name Service, Time Service, Game Management Service, Game Update Service, Event Management Service, Accounting Service, and Directory Service.

In some embodiments, the Progressive Server 238 hosts a value-add service that allows a wagering game machine to participate within a progressive gaming offering. Any value-add service can be added or substituted for this server/service. A progressive game offering is provided as an example. Other value-add services can be distributed on existing servers or reside on a newly added server.

The Customer Property 16 contains wagering game machines 10, which in some embodiments allow remote updates and configuration through a network interface on the wagering game machine. In some embodiments, a Boot Server 234 contains a DHCP service that facilitates the distribution of IP addressing to the wagering game machines 10. It should be noted that any device capable of supporting a wagering game could be substituted for wagering game machine 10. For example, a personal or laptop computer executing a wagering game may participate in the gaming network using the services described below.

As noted above, various services may be located throughout the gaming network. In some embodiments of the invention, a set of core operational services may include one or more of the following services:

| | |
|---|---|
| Boot Service | Provides dynamic IP addressing to devices upon |
| | boot (start-up). Typically supported by Dynamic |
| | Host Configuration Protocol (DHCP). |
| Discovery Service | Provides the address information of the server |
| | containing the service when prompted by the |
| | requestor as well as the service description, binding |
| | and location on the server. |
| Authentication | Contains the master Authentication Database. |
| Service | Authenticates the service user before allowing the |
| | use of services in the Gaming Services Framework. |
| Authorization | Contains the master Authorization Database. |
| Service | Authorizes the use of services in the Gaming |
| | Services Framework by a service requestor. |
| Gaming | Provides the ability to configure and monitor |
| Management | wagering game machines and other services from a |
| Service | central location. |
| Name Service | Provides name resolution service to enable machines |
| | in a gaming network to refer to each other by name |
| | instead of IP Address. In some embodiments the |
| | name service is implemented using the Domain |
| | Naming System (DNS) protocol. |
| Time Service | Provides global synchronization of time in the |
| | gaming network. This may be implemented by |
| | running the Network Time Protocol (NTP) client |
| | software on wagering game machines. |
| Directory Service | Provides a directory of various information related |
| | to the operation of machines, services and networks |
| | for a gaming infrastructure. |

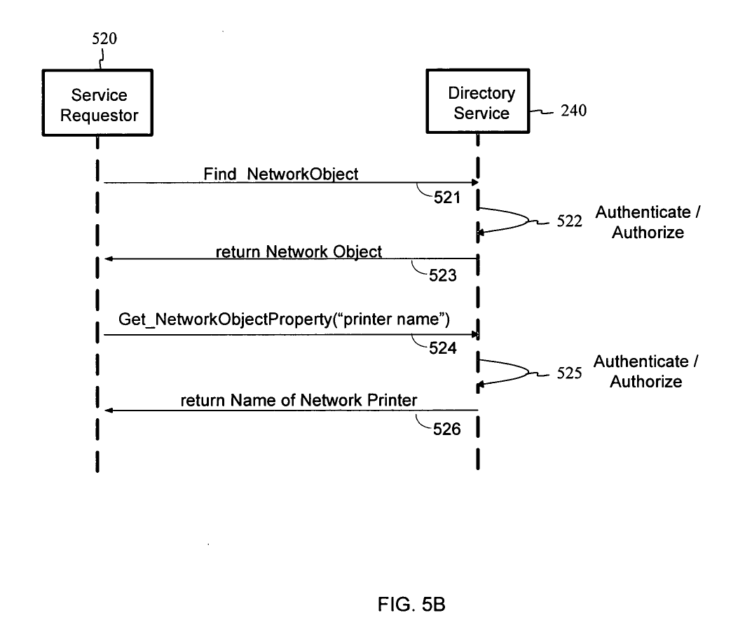

Further details on a directory service implemented in various embodiments of the invention are provided below with reference to FIGS. 5A and 5B.

In addition to or instead of the core services described above, some embodiments of the invention include one or more of the following services referred to as Basic Gaming Services:

| | |
|---|---|
| Accounting Service | Provides logging of transaction records for billing |
| | and general tracking purposes. |
| Event Management | Logs events occurring at client and server |
| Service | machines. |
| Game Update Service | Provides dynamic distribution of new or updated |
| | game content to wagering game machines. |
| Message Director | This service uses a software-configurable message |
| Service | routing application to facilitate the reliable |
| | exchange of data messages among multiple |
| | application processes within one or more gaming |
| | systems. |
| Content Integrity | This service provides the ability to verify the |
| Service | integrity of software components running in the |
| | gaming network. This includes the verification of |
| | software versions running on wagering game |
| | machines, peripherals, services as well the |
| | detection of tampering or modification of the |
| | software. |

As noted above, a gaming service network may include Value Add Services. These services include participation services and player services. Examples of participation services that may be included in various embodiments of the invention include the following:

| | |
|---|---|
| Progressive Service | Provides functionality for a wagering |
| | game machine to participate within a |
| | single progressive or multiple |
| | progressives. |
| Wide Area Disruption | This service takes over the processing |
| Progressive Service | of wide area progressives at each |
| | gaming site in the event that there is no |
| | connection with a central system or the |
| | connection with the central system is |
| | temporarily disabled. |
| Mobile Gaming Device GPS | This service processes the GPS |
| Service | location of wagering game machines |
| | compared with coordinates of a gaming |
| | jurisdiction. Example: players can ride |
| | a bus and begin gambling on the bus |
| | when the bus crosses into the gaming |
| | jurisdiction. |

Examples of Player Services that may be included in various embodiments of the invention include:

| | |
|---|---|
| Player Tracking | This service provides the operator and player with |
| Service | standard player tracking applications such as |
| | monitoring card in/card out transactions to track |
| | play and award player points for play, providing |
| | targeted promotional compensation to specific |
| | players, publishing account status to the player or |
| | operator, providing temporary wagering game |
| | machine locking in order to hold the machine for |
| | the player for short periods of time, and providing |
| | operators and players an interface and capability |
| | for Responsible Gaming Initiatives. |
| Game Theme | This service provides location information to |
| Location Service | clients regarding specific games, game themes or |
| | vendor brands. The service may publish the |
| | information by casino, by area, by city, by state, by |
| | region, by country, or by continent depending on |
| | the input parameters provided. An example would |
| | be to publish where all of the progressive games of |
| | a particular theme (e.g., “Monopoly Money) are |
| | located in a particular hotel (e.g., the Reno Hilton) |
| | in Reno, Nevada. |
| Personalization | This service provides the gaming player with a |
| Service | more personalized gaming environment. Example: |
| | the player could choose to see text in Chinese, |
| | could choose to be reminded of dinner reservation |
| | time, could customize machine graphics, or could |
| | have a portion of his coin in go to his football |
| | club's progressive. |
| Cashless | This service provides the ability for a player to |
| Transaction | transfer funds between financial institutions, in- |
| Service | house accounts and wagering game machines. |
| Bonusing Service | This service provides the ability for casinos to set |
| | up bonus games for a specific wagering game |
| | machine, carousel of machines or one or more |
| | game themes. |
| Game Service | This service is a server-side process that provides |
| | the outcome of game play. This service may be |
| | used to enable Internet/online gaming. |
| Advertising Service | This service allows the operator to display |
| | advertising information to players in multimedia |
| | format as well as simple audio and graphic |
| | formats. |
| Property Service | This is a group of services that provides the ability |
| | for the property management company to integrate |
| | with gaming systems. It can provide interaction |
| | with functions such as hotel and restaurant |
| | reservations. |

Directory service 240 provides directory information to directory clients such as wagering game machines 10 or other services such as those described above that may reside on a gaming infrastructure network. The directory information may be provided in response to a request from a client (e.g. a pull model). In some embodiments, directory service 240 comprises the Active Directory® system available from Microsoft Corp. of Redmond, Calif. However, the embodiments are not limited to a particular directory service. Alternative directory services include the Novell Directory Service™ and eDirectorym™ from Novell, Inc. of Provo, Utah and LDAP (Lightweight Directory Access Protocol), RADIUS (Remote Authentication Dial In User Service) and X.500 directory services.

Directory service 240 may be located on a local network at a customer gaming property 210 (e.g. directory service 240a), or on a customer data center 218 network (e.g. directory service 240b) coupled to customer gaming property 210 through network 220.

In addition, multiple directory services may be made available at customer gaming property 210 and/or customer data center 218. For example, one directory service may provide a generalized directory service (e.g. Active Directory) while a second directory service may provide security related directory services (e.g. RADIUS).

It should be noted that with the distributed architecture of the Gaming Service Network 210, the above-described services that reside on network servers are not limited to location and can reside anywhere the network supports. For example, it is desirable to consider security and network latency when locating services.

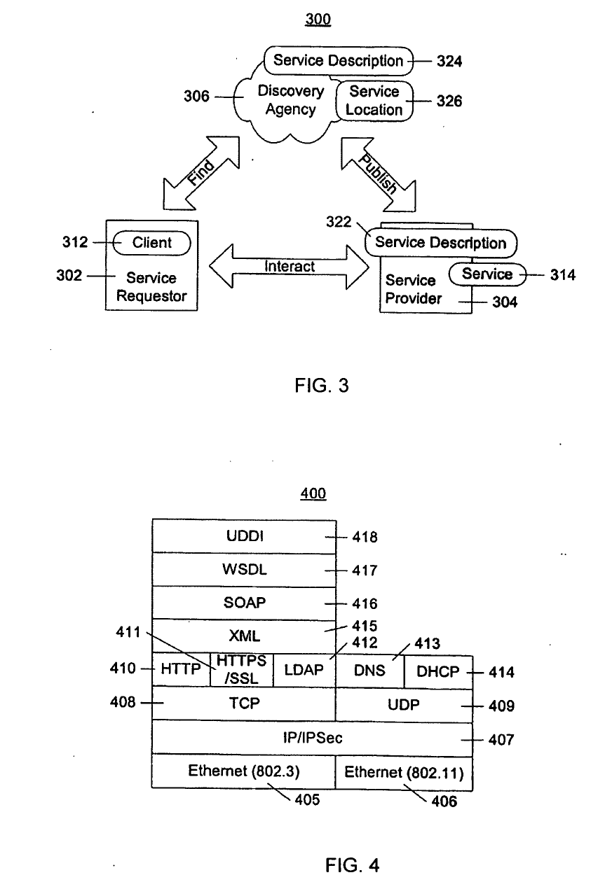

FIG. 3 is a block diagram of a Gaming Services Framework 300 according to various embodiments of the invention. In some embodiments, the Gaming Services Framework 300 includes a set of protocols, XML schemas, and methods for providing gaming system functionality in a distributed, network-based architecture such as the network described above in FIG. 2. In order to participate in such network-based architectures, the participating devices are interconnected via public or private networks that may be wired or wireless networks. Further, devices performing service communication support a common services protocol stack such as the Gaming Services Protocol Stack that is further described below.

The Gaming Services Framework 300 provides for the interaction of several logical elements as depicted in FIG. 3. Logical elements represent the fundamental entities that interact to implement a service. In some embodiments, these logical elements include Service Requestor 302, Service Provider 304, and Discovery Agency 306. In general terms, the roles these elements play are as defined in Web Services Architecture—W3C Working (Draft 14 Nov. 2002 and later versions). Further details on these elements are provided below.

Logical elements may reside in a number of different physical devices as part of delivering any service. For example, a Service Provider 304 will typically reside in a slot accounting or player tracking system and the Service Requestor 302 will typically reside in a wagering game machine. However, there may be scenarios where it would be advantageous or appropriate for the logical elements to reside in other physical devices. For example, in alternative embodiments a Service Requestor 302 may reside in a slot accounting system.

Service Provider 304 comprises a platform that provides access to a service 314. A service provider may also be referred to as a service execution environment or a service container. Its role in the client-server message exchange patterns is that of a server.

Service Requestor 302 comprises an application that is looking for and invoking or initiating an interaction with a service such as that provided by service provider 304. Its role in the client-server message exchange patterns is that of a client 312.

Discovery Agency 306 comprises a searchable set of service descriptions where service providers 304 publish their service description(s) 324 and service location(s) 326. The service discovery agency 306 can be centralized or distributed. A discovery agency 306 can support both patterns where service descriptions 322 are sent to discovery agency 306 and patterns where the discovery agency 306 actively inspects public service providers 304 for service descriptions 322. Service requestors 302 may find services and obtain binding information (in the service descriptions 324) during development for static binding, or during execution for dynamic binding. In some embodiments, for example in statically bound service requesters, the service directory agent may be an optional role in the framework architecture, as a service provider 304 can send the service description 322 directly to service requestor 302. Likewise, service requestors 302 can obtain a service description 324 from other sources besides a discovery agency 306, such as a local file system, FTP site, URL, or WSDL document.

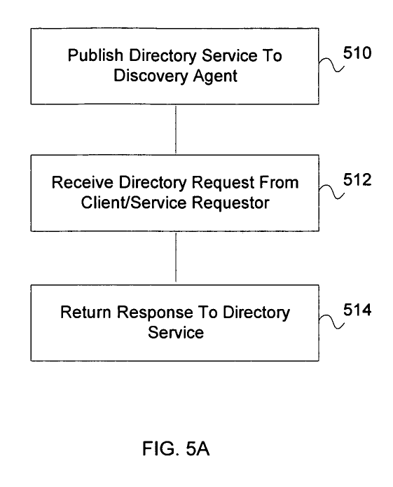

FIG. 4 provides a block diagram of a Gaming Services Protocol Stack 400 according to embodiments of the invention. In some embodiments, the protocol stack includes core layers that define basic services communication and transport, and are typically implemented uniformly. Higher layers that define strategic aspects of gaming processes are also described below. FIG. 4 illustrates both the widely implemented core layers and in addition illustrates the higher gaming services oriented layers of the protocol stack.

Core Layers of the Gaming Services Protocol Stack 400

In some embodiments, the gaming services framework utilizes common Internet protocols, which may include web services protocols. Although not specifically tied to any transport protocol, it is desirable to build the gaming services on ubiquitous Internet connectivity and infrastructure to ensure nearly universal reach and support. In some embodiments, gaming services will take advantage of Ethernet 405 or 406, Transmission Control Protocol (TCP) 408, Internet Protocol (IP) 407, User Datagram Protocol (UDP) 409, HyperText Transfer Protocol (HTTP) 410, HyperText Transfer Protocol Secure/Secure Socket Layer (HTTPS/SSL) 411, Lightweight Directory Access Protocol (LDAP) 412, Domain Naming System (DNS) 413, and Dynamic Host Configuration Protocol (DHCP) 414 layers in the protocol stack 400. Those of skill in the art will appreciate that other protocol layers performing equivalent functionality may be substituted for those described above and are within the scope of the inventive subject matter.

In some embodiments, service request and response data are formatted using Extensible Markup Language (XML) 415. XML 415 is a widely accepted format for exchanging data and its corresponding semantics. XML is a fundamental building block used in layers above the Common Internet Protocols. In some embodiments, the Gaming Services Protocol Stack 400 incorporates this protocol in accordance with the World Wide Web Consortium (W3C) XML Working Group's XML specification. However, those of skill in the art will appreciate that other data exchange formats may be substituted for XML 415, and such formats are within the scope of the inventive subject matter.

In some embodiments of the invention, the gaming service protocol stack 400 utilizes the Simple Object Access Protocol (SOAP) 416. SOAP 416 is a protocol for messaging and RPC (Remote Procedure Call) style communication between applications. SOAP is based on XML 415 and uses common Internet transport protocols like HTTP 410 to carry data. SOAP 416 may be used to define a model to envelope request and response messages encoded in XML 415. SOAP 416 messaging can be used to exchange any kind of XML 415 information. SOAP 416 is used in some embodiments as the basic standard for carrying service requests/responses between service users and providers. SOAP 416 has been submitted to the World Wide Web Consortium (W3C) standards body as recommendation documents (versions 1.1 and 1.2) and will likely emerge as “XML Protocol (XP).”

Higher Layers of the Gaming Services Protocol Stack 400

In some embodiments, the gaming services protocol stack includes a Web Services Description Language (WSDL) 417 and a Universal Description, Discovery, and Integration (UDDI) 418. WSDL 417 comprises a description of how to connect to a particular service. In some embodiments, WSDL 417 is based on XML. A WSDL 417 description abstracts a particular service's various connection and messaging protocols into a high-level bundle and forms an element of the UDDI 418 directory's information. WSDL 417 is similar to CORBA or COM IDL in that WSDL 417 describes programmatic interfaces. WSDL 417 is typically independent of the underlying service implementation language or component model, and focuses on an abstract description. The Gaming Services Protocol Stack 400 incorporates this description in accordance with the World Wide Web Consortium (W3C) Web Services Description Language (WSDL) 1.1—W3C Note 15 Mar. 2001 and later versions.

In some embodiments, UDDI 418 represents a set of protocols and a public directory for the registration and real-time lookup of services. UDDI 418 enables an entity such as a company to publish a description of available services to the registry, thereby announcing itself as a service provider. Service users can send requests conforming to the UDDI 418 schema as SOAP 416 messages to the service registry to discover a provider for services. Some embodiments of the invention may utilize UDDI Version 3, released in July of 2002 and later versions. Further development of UDDI 418 is managed under the auspices of the OASIS (Organization for the Advancement of Structured Information Standards) UDDI Specifications technical committee.

Returning to FIG. 3, the service requesters and service providers use the above-described protocol stack to perform service interactions with one another. The service interactions include publish 330, discover (find) 332, and interact 334.

Publish interaction 330 provides a mechanism for a service to be made accessible by other entities in the gaming network environment. In order to be accessible, a service needs to publish its description such that the requestor can subsequently find it. Where it is published can vary depending upon the requirements of the application. A service description 322 can be published using a variety of mechanisms known in the art. The various mechanisms used by the varying embodiments of the invention provide different capabilities depending on how dynamic the application using the service is intended to be. The service description may be published to multiple service registries using several different mechanisms. The simplest case is a direct publish. A direct publish means the service provider sends the service description directly to the service requestor. In this case the service requestor may maintain a local copy of the service description 322.

Another means of publishing service descriptions utilized in alternative embodiments of the invention is through a UDDI registry. There are several types of UDDI registries known in the art that may be used depending on the scope of the domain of Web services published to it. When publishing a Web service description to a UDDI registry, it is desirable to consider the business context and taxonomies in order for the service to be found by its potential service consumers. Examples of UDDI registries used in the gaming service architecture of various embodiments of the invention are Internal Enterprise Application UDDI registry, Portal UDDI registry, and Partner Catalog UDDI registry.

An Internal Enterprise Application UDDI registry may be used in some embodiments for gaming services intended for use within an organization for internal enterprise applications integration. For example, all services that provide gaming and gaming management to devices within a casino or casino organization may be published to an Internal Enterprise Application UDDI registry.

A Portal UDDI registry may be used in some embodiments for gaming services that are published by a company for external partners to find and use. A portal UDDI registry typically runs in the service provider's environment outside of a firewall or in a DMZ (de-militarized zone) between firewalls. This kind of private UDDI registry generally contains only those service descriptions that a company wishes to provide to service requestors from external partners through a network. For example, these services may be used to provide online gaming to customers connecting through the World-Wide Web.

A Partner Catalog UDDI registry may be used in some embodiments for gaming services to be used by a particular company. The Partner Catalog UDDI registry can be thought of as a rolodex like UDDI registry. A Partner Catalog UDDI registry is typically located on a computer or wagering game machine behind a firewall. This kind of private UDDI registry typically contains approved, tested, and valid service descriptions from legitimate (e.g. authorized) business partners. The business context and metadata for these services can be targeted to the specific requestor. In some embodiments, this type of registry may be used for inter-casino services as well as interactions between casinos and other types of organizations such as regulators and financial institutions. It is desirable that an appropriate authorization and qualification procedure be in place to insure that only approved services are published to service repositories.

In the discover interactions 332 (also referred to as find interactions), the service requestor retrieves a service description directly or queries the registry for the type of service required. It then processes the description in order to be able to bind and invoke it.

As with publishing service descriptions, acquiring service descriptions may vary depending on how the service description is published and how dynamic the service application is meant to be. In some embodiments, service requestors may find Web services during two different phases of an application lifecycle—design time and run time. At design time, service requesters search for web service descriptions by the type of interface they support. At run time, service requestors search for a web service based on how they communicate or qualities of service advertised.

With the direct publish approach noted above, the service requestor may cache the service description at design time for use at runtime. The service description may be statically represented in the program logic, stored in a file, or in a simple, local service description repository.

Service requestors can retrieve a service description at design time or runtime from a Web page (URL), a service description repository, a simple service registry or a UDDI registry. The look-up mechanism typically supports a query mechanism that provides a find by type of interface capability (for example, based on a WSDL template), the binding information (i.e. protocols), properties (such as QOS parameters), the types of intermediaries required, the taxonomy of the service, business information, etc.

The various types of UDDI registries, including those described above, have implications on the number of runtime binding services can choose from, policy for choosing one among many, or the amount of pre screening that will be done by the requestor before invoking the service. Service selection can be based on binding support, historical performance, quality of service classification, proximity, or load balancing. It is desirable that an appropriate authorization and qualification procedure be in place to insure that only approved services are published to service repositories.

Once a service description is acquired, the service requestor will need to process it in order to invoke the service. In some embodiments, the service requestor uses the service description to generate SOAP requests or programming language specific proxies to the service. The generation of such requests can be done at design time or at runtime to format an invocation to the service. Various tools can be used at design time or runtime to generate programming language bindings from interface descriptions, such as WSDL documents. These bindings present an API (Application Program Interface) to the application program and encapsulate the details of the messaging from the application.

After a service has been published 330 and discovered 332, the service may be invoked so that a service requestor and service provider may interact 334. In the interact operation 334, the service requestor invokes or initiates an interaction with the service at runtime using the binding details in the service description 322 to locate, contact, and invoke the service. Examples of service interactions 334 include: single message one way, broadcast from requester to many services, a multi message conversation, or a business process. Any of these types of interactions can be synchronous or asynchronous requests.

In some embodiments of the invention, security mechanisms may be used to secure the Gaming Services Framework 300. Securing the Gaming Services Framework typically involves providing facilities for ensuring the integrity and confidentiality of the messages and for ensuring that a service acts only on requests in messages that express the claims required by policies. Examples of such mechanisms used in various embodiments of the invention include IPSec and SSL/TLS, which provide network and transport layer security between two endpoints. However, when data is received and forwarded on by an intermediary beyond the transport layer both the integrity of data and any security information that flows with it maybe lost. This forces any upstream message processors to rely on the security evaluations made by previous intermediaries and to completely trust their handling of the content of messages. Thus it is desirable to include security mechanisms that provide end-to-end security. It is also desirable that such mechanisms be able to leverage both transport and application layer security mechanisms to provide a comprehensive suite of security capabilities.

### Directory Service

In general, the various embodiments of the invention implement a directory service for a gaming network. The directory service is responsible for storing information about network-based entities. The directory service acts as a central repository that manages the identities and maintains the relationships between distributed network resources, which allow these resources to work together. Some of the network entities that access and store information in the directory service include printers, files, users, and applications such as email management programs. The directory service provides a consistent method of naming, finding, describing, supporting, accessing, managing, and securing network resource data. The directory service may play a role in system administration functions and maintenance of network infrastructures. In varying embodiments, the directory services may include one or more of LDAP, RADIUS, and Microsoft Active Directory, et al.

A directory service is a software application, or set of applications, which stores and organizes information about a network and its resources—such as users, files, printers, servers, and applications—and allows administrators to manage access to these resources. It also provides transparency in regard to the location of these resources so users can make use of them without having to be concerned with the structure of the network.

A directory service typically includes a directory database that holds the information about objects that are to be managed by the directory service. The directory service is the interface to the directory and provides access to the data that is contained in that directory. It acts as a central authority that can securely authenticate resources and manage identities and relationships between them.

A directory service may be highly optimized for reads and provides advanced search on the many different attributes that can be associated with objects in a directory. The data that is stored in the directory is defined by an extendable and modifiable schema. Directory services may use a distributed model for storing their information and that information may be replicated between directory servers.

A directory service maps the names of network resources to their respective network addresses. The user doesn't have to remember the physical address of a network resource; providing a name helps locate the resource. Each resource on the network is considered as an object on the directory server. Information about a particular resource is stored as attributes of that object. Information within objects can be made secure so that only users with the available permissions are able to access it.

A directory service defines the namespace for the network. A namespace is a set of rules that determine how network resources are named and identified. The rules specify that the names are unique and unambiguous. In LDAP the name is called the distinguished name (DN) and is used to refer to a collection of attributes which make up a directory entry.

FIGS. 5A and 5B are flow diagrams illustrating methods for providing a directory service according to embodiments of the invention. The methods may be performed within an operating environment such as that described above with reference to FIGS. 1-4. The methods to be performed by the operating environment constitute computer programs made up of computer-executable instructions. Describing the methods by reference to a flow diagram enables one skilled in the art to develop such programs including such instructions to carry out the methods on suitable computers (the processor of the computer executing the instructions from machine-readable media such as RAM, ROM, CD-ROM, DVD-ROM, flash memory etc.). The methods illustrated in FIGS. 5A and 5B are inclusive of the acts performed by an operating environment executing an exemplary embodiment of the invention.

FIG. 5A is a flow diagram illustrating a method for providing a directory service in a service-oriented gaming network. In the detailed description of the method below, particular method names may be provided for particular embodiments of the invention. It should be noted that such names are exemplary in nature, and the inventive subject matter is not limited to any functionality that may be implied by the name.

The method begins when a directory service registers on a gaming network (block 510). In some embodiments, the service is registered by sending a description (e.g. in WSDL) of the service to the discovery agency. In particular embodiments, the registry may be a UDDI registry. The directory service is then hosted on a server so that clients can access it. In some embodiments, the directory service is hosted on a web server as a web service. At this point the service is available for discovery by interested parties.

After the directory service is registered, clients/service requesters may make directory requests to obtain information on available services on the network (block 512). In some embodiments, a client may make UDDI calls to the discovery agency to find a Directory Service. The discovery agency returns the service description and location information to the client In some embodiments, the client will have embedded knowledge of the location of the directory service. This may be accomplished by having the directory service assigned to a well known address such as a particular URL, TCP/IP port or service name. Other mechanisms of embedding knowledge of the location of the directory service are known in the art and within the scope of the inventive subject matter. Clients such as wagering game machines or other gaming services need not register prior to making requests of the directory service.

In some embodiments, one or more of the request methods detailed below may be supported: The following invocation methods are used by the client to locate and gather details about the network objects that are stored in the directory service. Each of the methods could be implemented as a SOAP call.

| | |
|---|---|
| find_NetworkObject | Returns one or more network |
| | objects that match the provided |
| | query string. |
| create_NetworkObject | Creates a network object within |
| | the directory service. |
| Remove_NetworkObject | Removes a network object from |
| | the directory service. |
| add_ChildObject | Used to add a child network object |
| | to a group network object. |
| remove_ChildObject | Used to remove a child network |
| | object from a group network |
| | object. |
| add_GroupObject | Used to add a group network |
| | object to the directory service. |
| remove_GroupObject | Used to remove a group network |
| | object from the directory service. |
| move_NetworkObject | Used to move a network object to |
| | a different location within the |
| | directory service. |
| get_NetworkObjectParent | Used to obtain a reference to the |
| | parent of a network object. |
| get_ChildObjects | Used to obtain references to the |
| | child objects of a network group |
| | object. |
| get_NetworkObjectProperties | Used to obtain the property |
| | values of all properties associated |
| | with a network object. |
| get_NetworkObjectProperty | Used to obtain the property value |
| | of a specific property associated |
| | with a network object. |
| Add_NetworkObjectProperty | Used to add a new property and |
| | its associated property value to a |
| | network object. |
| remove_NetworkObject | Used to remove a network object |
| | from the directory service. |
| networkObjectExists | Used to return a Boolean vale |
| | indicating if a network object |
| | exists in the directory service. |

FIG. 5B illustrates a method for a client to utilize a directory service according to an embodiment of the invention and illustrates an example usage scenario for finding a network object (in this example, a network printer) involving a message sequence 500. The message sequence 500 shown in FIG. 5B describes the method of a service requestor 520 making a directory service request to a directory service 240 to find a network printer on a gaming network. Service requestor service 520 may be a wagering game machine or any of the services described above, or additional services provided in a gaming network. The inventive subject matter is not limited to any particular service seeking to use a directory service. Additional information for each message is provided below as defined by the block identification number in FIG. 5B. It is noted that the method is described in part with reference to UDDI and SOAP, however, no embodiment of the invention is limited to UDDI and/or SOAP, and other directory and communications mechanisms may be used in place of UDDI and/or SOAP.

At block 521, a service requestor client searches in the directory service for a printer connected to the network.

At block 522, the Directory Service authenticates and authorizes the service requestor client.

At block 523, the Directory Service returns an object representing a network printer back to the service requestor client.

At block 524, the service requestor client requests the name associated with the network printer object.

At block 525, the Directory Service authenticates and authorizes the service requestor client.

At block 526, the Directory Service returns the name of the requested network printer.

It should be noted that the example message sequence is but one example of many possible message sequences involving requests for information from a directory service, and that other sequences are possible and within the scope of the inventive subject matter.

### Conclusion

Systems and methods providing a directory service in a service-oriented gaming network environment have been disclosed. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that the inventive subject matter be limited only by the following claims and equivalents thereof.

What is claimed is:

1. A method for providing a directory service to wagering game machines in a gaming network, the method comprising:
registering a directory service on the gaming network;
processing one or more directory service requests between a wagering game machine communicably coupled to the gaming network and the directory service, said service requests conforming to an intemetworking protocol.

2. The method of claim 1, wherein the directory service comprises a web service.

3. The method of claim 2, wherein the directory service is specified according to a service description language.

4. The method of claim 3, wherein the service description language is a Web Services Description Language (WSDL)

5. The method of claim 1, wherein the directory service comprises a service selected from the group consisting of: Active Directory service, RADIUS (Remote Authentication Dial In User Service) directory service, LDAP (Lightweight Directory Access Protocol) directory service, and X.500 directory service.

6. The method of claim 1, wherein the directory request comprises a request to find a network object.

7. The method of claim 1, wherein the directory request comprises a request to add a child object to a network object.

8. The method of claim 1, wherein the directory request comprises a request for a property of a network object.

9. The method of claim 1, wherein the directory request comprises a request to add a network object to a group of network objects.

10. The method of claim 1, further comprising authenticating a service requester issuing the service request.

11. The method of claim 1, wherein registering the directory service comprises registering the directory service in a UDDI (Universal Description, Discovery, and Integration) registry.

12. A system comprising:
at least one wagering game machine communicably coupled to a gaming network; and
a directory service communicably coupled to a gaming network, the directory service operable to:
register the directory service on the gaming network; and
process one or more directory requests between the at least one wagering game machine and the directory service, the service requests conforming to an internetworking protocol.

13. The system of claim 12, wherein the directory service comprises a web service.

14. The system of claim 12, wherein the web service is specified according to a service description language.

15. The system of claim 14, wherein the service description language is a Web Services Description Language (WSDL)

16. The system of claim 12, wherein the directory service comprises a service selected from the group consisting of: Active Directory service, RADIUS directory service, LDAP directory service, and X.500 directory service.

17. A computer-readable medium having computer executable instructions for performing a method, the method comprising:
registering a directory service on a gaming network;
processing one or more directory service requests between a wagering game machine communicably coupled to the gaming network and the directory service, said service requests conforming to an intemetworking protocol.

18. The computer-readable medium of claim 17, wherein the directory service comprises a service selected from the group consisting of: Active Directory service, RADIUS directory service, LDAP directory service, and X.500 directory service.

19. The computer-readable medium of claim 17, wherein the directory request comprises a request to find a network object.

20. The computer-readable medium of claim 17, wherein registering the directory service comprises registering the directory service in a UDDI registry.
